(19) United States
(12) Patent Application Publication
(10) Pub. No.: US 2012/0331094 A1
(43) Pub. Date: Dec. 27, 2012

(54) Multi-party reporting in profile-based data collection

(75) Inventors: GEORGE E. HOFFMAN, SAN JOSE, CA (US); FERDINAND FRANCIS BOUDREAU, III, ALVIN, TX (US)

(73) Assignee: CARRIER IQ, INC., MOUNTAIN VIEW, CA (US)

(21) Appl. No.: 13/245,860

(22) Filed: Sep. 27, 2011

Related U.S. Application Data
(60) Provisional application No. 61/501,647, filed on Jun. 27, 2011.

(51) Int. Cl. G06F 15/16

(52) U.S. Cl. 709/217

(57) ABSTRACT

A multi-client data collection agent. Multiple parties provision (“task”) and maintain profiles on a single device. The agent is responsible for maintaining and executing these multiple profiles and their associated collected data, and for reporting up to each of the tasking authorities on the schedule each one specifies. The agent is controlled by the multiple profiles to record metrics and user selections, transform the data into a plurality of packages, and transmit the packages to at least one destination package reception server determined in each profile. A priority screen enables resolution of conflicts over scarce resources.

### DESCRIPTION

Related Applications: Ser. No. 11/175,857 filed 5 Jul. 2005 issued as U.S. Pat. No. 7,609,650 on Oct. 27, 2009 discloses data collection agents and data collection profiles. Other related applications with common assignee include: U.S. Ser. Nos. 11/175,572, 12/346,370, 12/371,190, 12/371,204, 12/849,800, and 13/043,347. A co-pending related application ______ “Authentication and authorization method for tasking in profile-based data collection” was filed ______. This application claims priority from PPA 61/501,647 filed 27 Jun. 2011.

### BACKGROUND

1. Field of the Invention

The present invention relates generally to recording network and device parameters on wireless devices and related systems. More particularly, exemplary embodiments of the invention concern systems and methods for using distributed wireless devices to collect information about communication networks and user interaction with applications and services of wireless devices.

2. Related Technology

Conventional approaches tend to emphasize the use of pre-configured data gathering software. While the software can be instructed to collect certain subsets of data, the software cannot be quickly revised or modified to accommodate rapidly emerging and changing conditions. That is, the software can only collect the data that was originally programmed to be collected and further, such data can only be collected in accordance with the conditions initially programmed. Thus, the capabilities of such software are constrained by the foresight of the programmer. Because it is simply not possible for a programmer to be able to anticipate the wide variety of usage conditions, problems and events that may occur in connection with wireless devices and their users, this lack of flexibility is a significant limitation on the richness of data which can be conveniently analyzed.

Conventional profile-based data collection (as described by U.S. Pat. Nos. 7,551,922, 7,609,650, 7,865,194) provides enormous flexibility in gathering and processing data sourced from mobile devices but inserts a single point of failure and loss of privacy in collecting the data from diverse sources. Modern complex and heterogeneous mobile business environments mean that many (in some cases, competing) parties stand to gain from access to the data being collected, and these parties have varying (and sometime conflicting) needs and restrictions on data collection based on their various agreements with the consumer. These challenges make maintaining a single point of control over profile provisioning very complex from legal, technical, and business perspectives. Furthermore, even when technology drives resources to become relatively inexpensive, there will always be some limit to the availability of high performance resources or a conflict in priority.

It can be appreciated that what is needed is a more sophisticated and secure system to conduct many diverse survey studies across a large population of users without loss of confidentiality and serving the needs of unrelated and possibly competing interested parties.

### SUMMARY OF AN EXEMPLARY EMBODIMENT OF THE INVENTION

One aspect of the invention is a multi-facetted agent. Such an agent can allow multiple parties to provision (“task”) and maintain profiles on a single device, effectively allowing each tasking authority to talk to its own “virtual” agent which solely serves its needs. The agent is responsible for maintaining and executing these multiple profiles and their associated collected data, and for reporting up to each of the tasking authorities on the schedule they specify. This behavior has limited visibility to other on-device clients of the agent and to tasking authorities. The agent still receives a single stream of metrics from the system, and performs profile-specific filtering and processing on those metrics for each profile being obeyed at any given time.

A data collection agent in a wireless device records metrics and user responses as set out in two or more separately provisioned data collection profiles. Each profile may be replaced with another profile for more details or for a different study.

Each study is provided with at least one data collection profile. The profile is executed by a data collection agent to record metrics inter alia about the wireless device, user behaviors, applications and service, the communication environment, or perhaps the user's opinions and preferences about the device, the applications or services. The data collection profile also specifies transformations, and schedules and destinations for uploading the transformed data.

A data collection agent may observe and record data about applications, communications, and services as enabled by a user. If configured, the data collection agent may solicit user inputs about the quality or desirablity of interactions with the applications and services accessed on the wireless device. It may relate to activity when the device is not connected to a network or has lost connectivity with the network. The data collection agent, controlled by each resident data collection profile transforms the received metrics into a package and uploads to a package reception server, if appropriate. Each data collection profile contains criteria to discard the package or to schedule the upload of package to a chosen destination.

Each data collection profile describes for a particular study what parameters should be captured, and what events will cause data to be captured, stored, and uploaded. The data collection profile is downloaded from a resource in the network to a data collection agent on the wireless devices. In accordance with the instructions specified in the resident data collection profiles, the data collection agent on the wireless devices receives, stores, packages and uploads the specified data to one of a plurality of destinations. These and other aspects of embodiments of the present invention will become more fully apparent from the following description and appended claims.

Each data collection profile determines which device characteristics quantify performance and how often and what conditions should be stored. The data collection profile may further determine which interactions between the user and software applications are monitored and record those user behaviors and/or attitudes.

In an embodiment, all profiles are not equal in priority. A data collection agent is further controlled by a dynamically adjustable priority screen which allows the agent to suppress part or all of a lower priority profile in favor of a higher priority profile to allocate the resources available within each device.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a communications network in which the system may be practiced;

FIG. 2-4 illustrates block diagrams of apparatus; and

FIG. 5-7 illustrates a flowchart of a method.

### DETAILED DESCRIPTION OF EMBODIMENTS OF THE INVENTION

One aspect of the invention is a method for controlling a processor on a wireless device to record metrics desired by a plurality of tasking authorities, the method comprising:
within a multi-facetted agent, subscribing to a stream of metrics,
transforming metrics according to definitions in each of a plurality of profiles,
determining a package of metrics to be transmitted according to each of a plurality of profiles, and
transmitting a package on a schedule and to a destination according to each one of a plurality of profiles.

In an embodiment, the method further comprises filtering metrics according to each of a plurality of profiles.

In an embodiment, the method further comprises storing transformed metrics according to each of a plurality of profiles.

An other aspect of the invention is a method for operation of a multi-client agent comprising

receiving a first profile from a first tasking authority; and

receiving a second profile from a second tasking authority.

In an embodiment, the method further comprises
extracting from each received profile its desired metrics,
combining all desired metrics into a single subscription, and
subscribing to the stream of all metrics desired by any received profile.

In an embodiment, the method further comprises
setting triggers on the stream of metrics for each process defined in each received profile,
transforming metrics according to the instructions of each received profile,
filtering metrics according to the instructions of each received profile, and
storing profile specific metrics and transformations.

In an embodiment, the method further comprises
determining an upload rule for each received profile,
triggering on the satisfaction of and upload rule,
packaging stored profile-specific metrics and transformations for upload, and
transmitting the packaged profile-specific metrics and transformations to a destination specified in each received profile.

In an embodiment, an upload rule is at least one of a timer or a schedule, or an event condition in the metric stream.

An other aspect of the invention is an apparatus which comprises a processor configured as a multi-client agent.

In an embodiment, the multi-client agent can allow multiple parties to provision (“task”) and maintain profiles on a single device, effectively allowing each tasking authority to talk to its own “virtual” agent which solely serves its needs.

In an embodiment, the agent is responsible
for maintaining and executing each instruction provided within multiple profiles,
for storing data collected by each profile, and
for reporting up to each of the tasking authorities on the schedule specified within each profile.

In an embodiment of the apparatus above: maintaining, executing, storing, and reporting for one client profile has limited visibility to other on-device clients of the agent and to tasking authorities.

In an embodiment, the agent

receives a single stream of metrics from the system,

performs profile-specific filtering, and

processes metrics for each profile being obeyed at any given time.

An other aspect of the invention is an apparatus which comprises a baseband processor communicatively coupled to a processor and a multi-client agent circuit and a plurality of profile circuits wherein a circuit may be a processor configured by instructions encoded in non-transitory computer readable storage wherein each profile circuit is provisioned by a different tasking authority to collect, package, and transmit metrics to a specified destination and the multi-client agent circuit subscribes to a datastream from the baseband processor to serve all the requirements of all the profile circuits.

Reference will now be made to the drawings to describe various aspects of exemplary embodiments of the invention. It should be understood that the drawings are diagrammatic and schematic representations of such embodiments and, accordingly, are not limiting of the scope of the present invention, nor are the drawings necessarily drawn to scale.

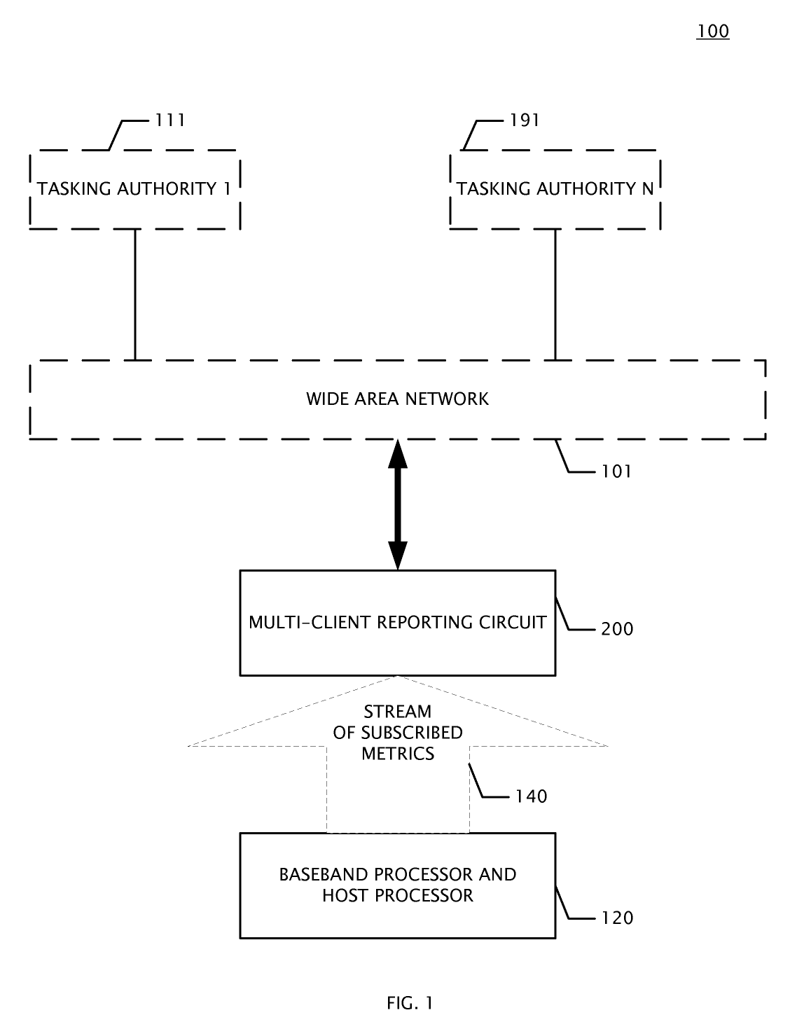

FIG. 1 is a schematic of a system for controlling a multi-client reporting circuit from a plurality of tasking authorities. A wide area network 101 such as the Internet, communicatively couples a plurality of tasking authorities 111-191 to a multi-client reporting circuit 200. The multi-client reporting circuit receives a stream of subscribed metrics 140 from a host processor and a baseband processor 120 of a wireless device. The subscribed metrics are selected by a superset of the metrics desired by each of the tasking authorities to which the multi-client reporting circuit is coupled.

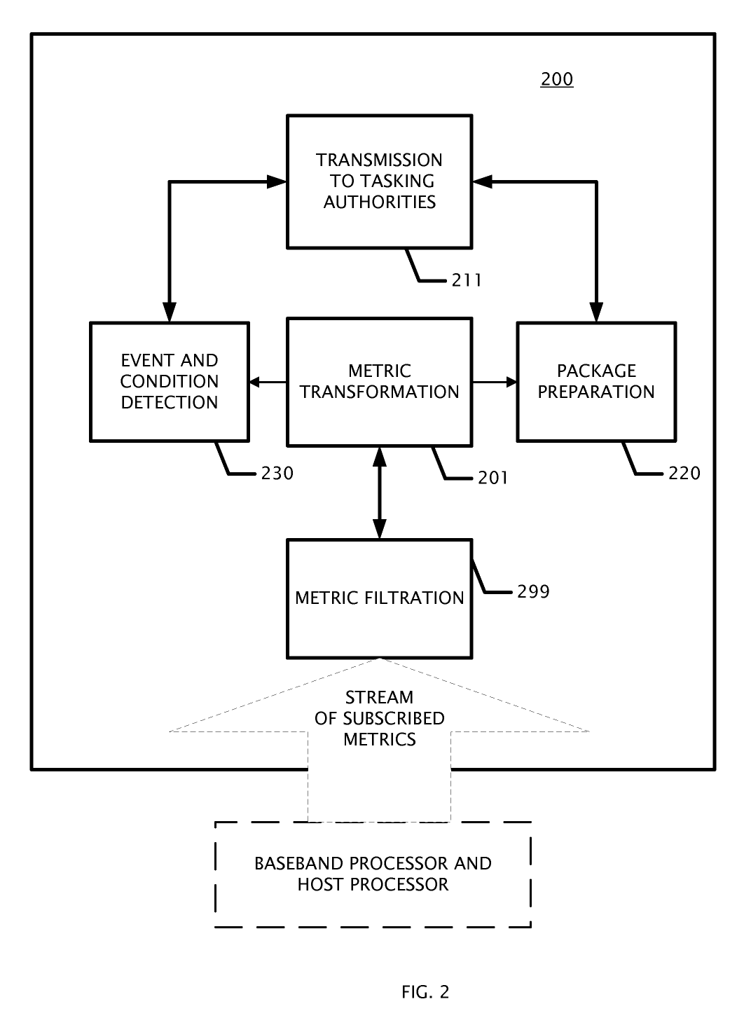

FIG. 2 is a block diagram of the multi-client reporting circuit apparatus 200 which comprises a plurality of circuits, in embodiments processors configured by software, to perform the following according to each profile received from a tasking authority: A metric filtration circuit 299 receives a stream of subscribed metrics and may discard any that do not fulfill requirements of the profile. A metric transformation circuit 201 receives filtered metrics and applies transformations specified within the profile which may be used to prepare a package 220 or used to detect an event or condition 230. Upon some trigger, or schedule, event, or condition, a transmission circuit 211 sends a package of metrics and transformed metrics to a tasking authority which provided the profile. Each circuit of 200 is reconfigured according to a new profile.

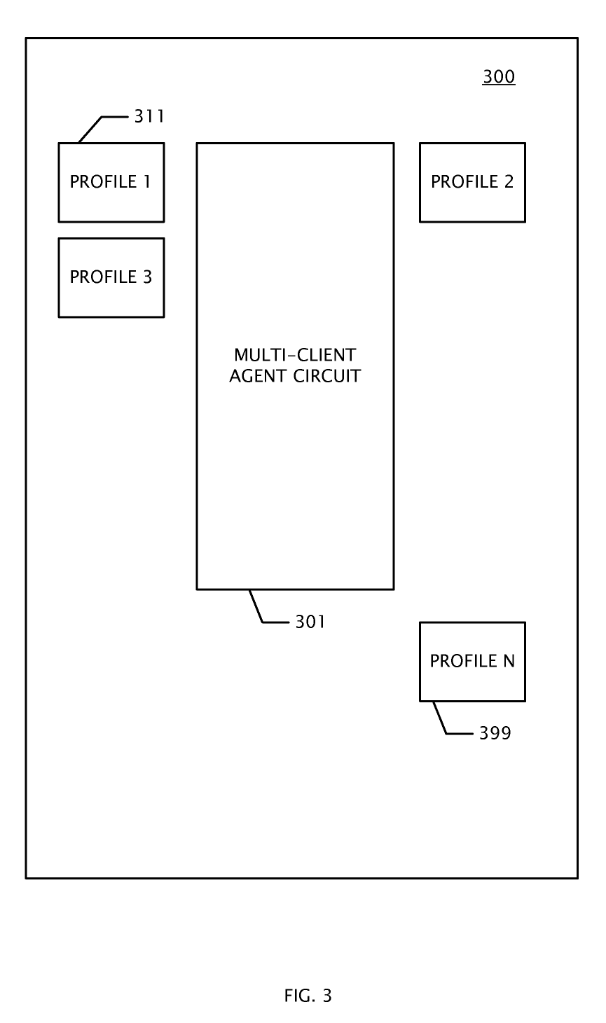

FIG. 3 is a schematic of the multi-client reporting circuit apparatus showing its components at another level of abstraction which comprises one multi-client agent circuit 301 and a plurality of profile circuits 311-399. Each profile circuit specifies metrics to be subscribed to, their transformations, events or conditions of interest to the tasking authority and the schedule, destination, and contents of packages.

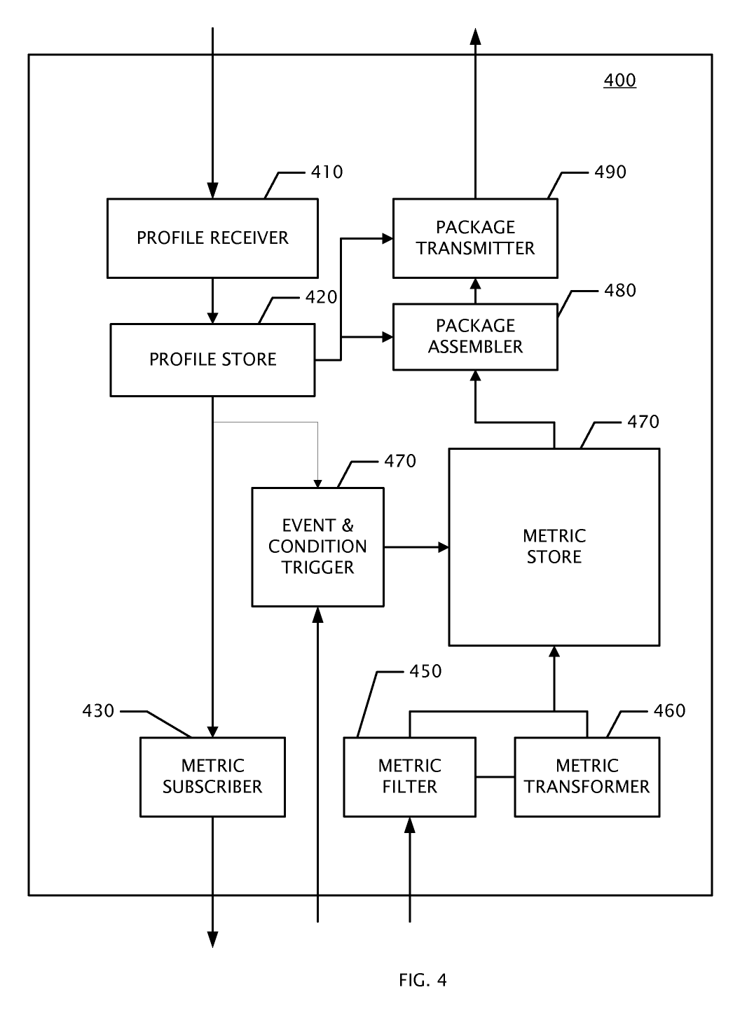

FIG. 4 is a more detailed block diagram of one embodiment of a multi-client reporting circuit 400. A profile receiver circuit 410 receives a plurality of profiles from tasking authorities, and records each one into profile store 420. A metric subscriber circuit 430 requests from the processor and broadband processor of a wireless device, a superset of all the metrics requested in profile store. The stream of metrics are received both by a metric filter 450 and by an event and condition trigger 470 which are both configured by a profile. The metric filter is further coupled to a metric transformer circuit which can add state analysis of metrics sequentially filtered. Both metrics and transformed metrics are recorded in metric store 470. Upon some event or condition including but not limited to a simple schedule or timer, a package assembler circuit 480 requests contents from the metric store and provides a package to a package transmitter 490. Both the contents of the package and its schedule for transmission to the tasking authority are defined in the profile store 420.

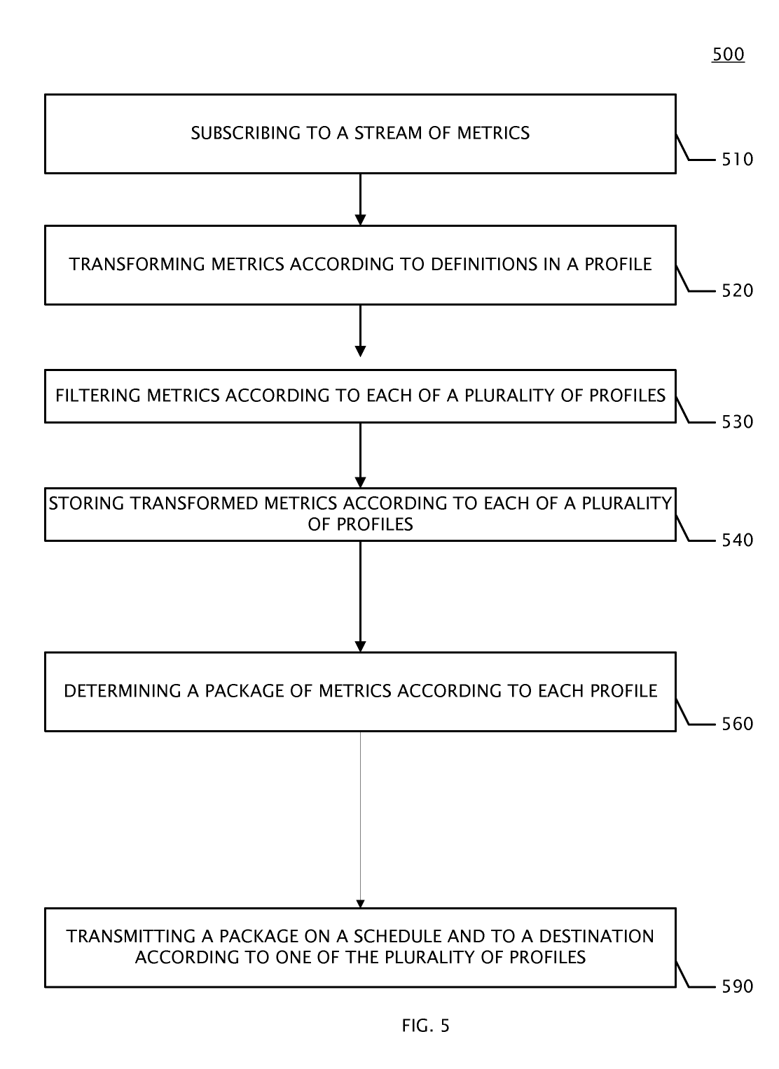

FIG. 5 is a flowchart of a method embodiment of the invention which comprises:

subscribing to a stream of metrics 510;

transforming metrics according to definitions in each of a plurality of profiles 520;

filtering metrics according to each of a plurality of profiles 530;

storing transformed metrics according to each of a plurality of profiles 540;

determining a package of metrics according to each profile 560; and

transmitting a package on a schedule and to a destination according to one of the plurality of profiles 590.

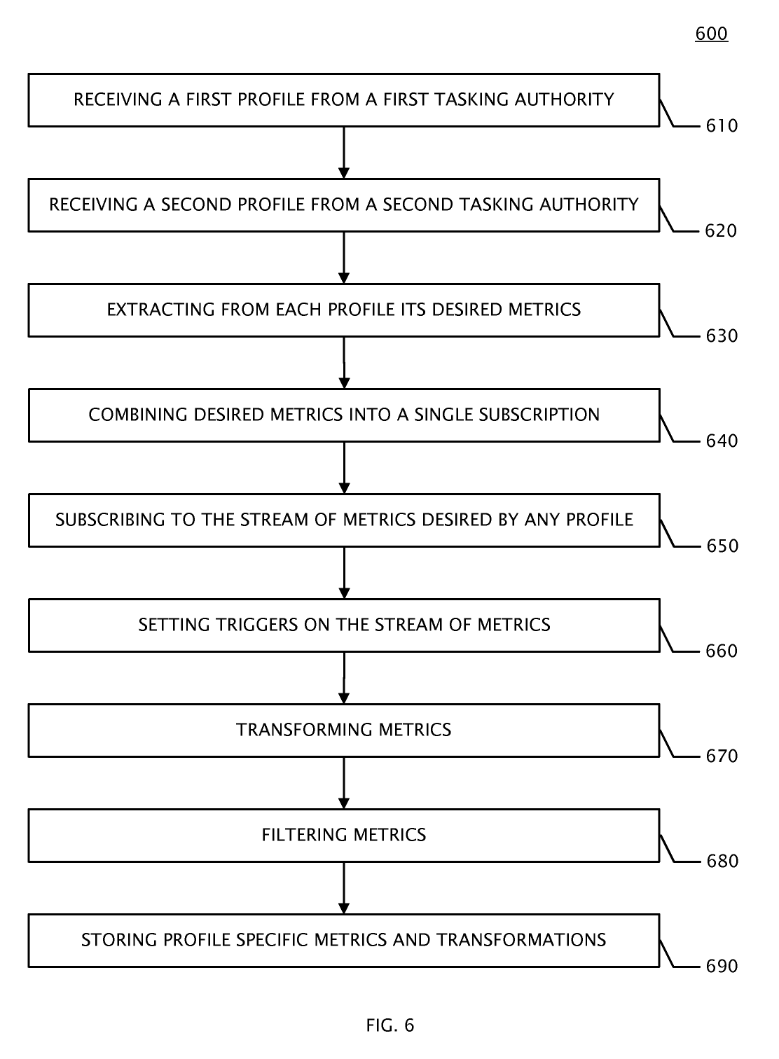

FIG. 6 is a flowchart of a method for operation of an apparatus:

receiving a first profile from a first tasking authority 610;

receiving a second profile from a second tasking authority 620;

extracting from each received profile its desired metrics 630;

combining desired metrics into a single subscription 640;

subscribing to the stream of metrics desired by any profile 650;

setting triggers on the stream of metrics 660;

transforming metrics 670;

filtering metrics 680; and

storing profile-specific metrics and transformation 690.

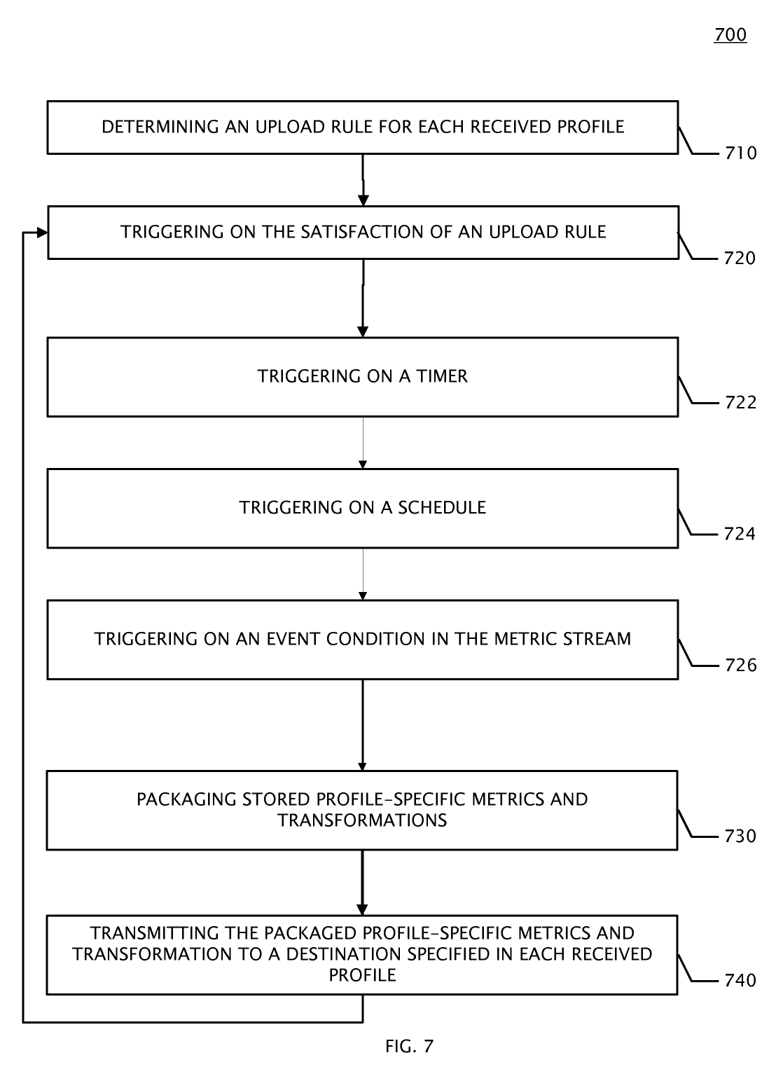

FIG. 7 is a flowchart of additional steps for operation of an apparatus:
determining an upload rule for each received profile 710;
triggering on the satisfaction of an upload rule 720;
triggering on a timer 722;
triggering on a schedule 724;
triggering on an event or condition in the metric stream 726;
packaging stored profile-specific metrics and transformations 730; and
transmitting the packaged profile-specific metrics and
transformations to a destination specified in each received profile 740.

Rules in the data collection profile direct assignment of metrics to buffers and link triggers to generated metrics by matching the identifiers in the common aspects of the metrics data structure. Data collection profiles can be implemented that define survey rules, triggers and buffers for metrics requirements that arise after production and implementation of the agent.

In an embodiment, a profile comprises executable program instructions in binary code, in interpretive code, in procedural code, or in 4th generation language to manipulate data and metrics at the adaptive agent. The executable instruction may compress metrics into packages, summarize a series of events or behaviors, recognize a pattern, monitor a state machine, trigger an upload, change a destination uniform resource identifier, initiate a new package, change a package definition, mask or unmask portions of a profile to enable or disable subscribing to a datastream, enable or disable recording of parameters or behaviors, maintain a rolling history of observations, events, records, send notifications of an event, compute or trace.

Multiple profiles may coexist in a device to control one agent. A profile may adapt to different circumstances and record different performance parameters and user behaviors. A profile may determine that another profile is appropriate. A profile may trigger recording certain metrics and evaluations based on prior other recorded metrics and conditions.

A profile includes a schedule or trigger for upload, a fallback for upload failure, a destination Uniform Resource Identifier (URI) and a plurality of device metrics and user inputs to assemble into at least one package. In an embodiment the profile contains program code to perform computations or thresholds to determine if an upload is enabled or disabled. Program code within a profile may alter the selection or transformation of metrics or sense a sequence of events which trigger a specialized set of procedures or launch a user interface. The program code within a profile may determine the appropriate combination of metrics for a condition or state.

Each individual profile controls what an agent records, filters, and combines a plurality of metrics and recordations into at least one package for one tasking authority. In an embodiment a profile can determine a schedule for uploading a package. At a first step in filtering, an agent controlled by a profile may discard data which is not useful

In an embodiment, when an agent determines that a resource limitation does not allow fulfillment of all its profiles, it refers to a dynamically adjustable priority screen which is updated each time each profile is received by the wireless device. Two wireless devices may have the same profiles but allocate resources differently according to different priority screens. The profiles themselves cannot contain their own priorities relative to all other profiles.

In embodiments, a priority screen is generated for each wireless device to control the priority of each data collection profile in resource allocation. In an embodiment the method further comprises receiving, at a data collection agent of each wireless device, a priority screen which assigns a relative priority of each data collection profile to receive resources available on the wireless device. In one embodiment, the method further comprises assigning resources on the wireless device to each of the data collection profiles according to the priority set within a priority screen. In another embodiment, the method further comprises comparing the resources available on a wireless device to a priority screen and determining which data collection profile(s) will not be resourced due to its position in said priority screen relative to other data collection profiles.

### Means, Embodiments, and Structures

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a non-transitory computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the claims.

### CONCLUSION

The present invention can be distinguished from conventional systems that do not provide a plurality of data collection profiles to a data collection agent which may be simultaneously operated with a plurality of data collection profiles corresponding to different survey studies. The present invention is easily distinguished from conventional systems by a data collection agent which is simultaneously controlled by plurality of data collection profiles for different surveys. Thus a single stream of metrics may be filtered and packaged for two or more independent and mutually unconscious tasking authorities. The agent may further receives a priority screen to resolve conflicts between profiles over limited resources.

What is claimed is:

1. A method for controlling a processor on a wireless device to record metrics desired by a plurality of tasking authorities, the method comprising:
within a multi-facetted agent, subscribing to a stream of metrics,
transforming metrics according to definitions in each of a plurality of profiles,
determining a package of metrics to be transmitted according to each of a plurality of profiles, and
transmitting a package on a schedule and to a destination according to each one of a plurality of profiles.

2. The method of claim 1 further comprising filtering metrics according to each of a plurality of profiles.

3. The method of claim 1 further comprising storing transformed metrics according to each of a plurality of profiles.

4. A method for operation of a multi-client agent comprising
receiving a first profile from a first tasking authority; and
receiving a second profile from a second tasking authority.

5. The method of claim 4 further comprises
extracting from each received profile its desired metrics,
combining all desired metrics into a single subscription, and
subscribing to the stream of all metrics desired by any received profile.

6. The method of claim 5 further comprises
setting triggers on the stream of metrics for each process defined in each received profile,
transforming metrics according to the instructions of each received profile,
filtering metrics according to the instructions of each received profile, and
storing profile specific metrics and transformations.

7. The method of claim 6 further comprises
determining an upload rule for each received profile,
triggering on the satisfaction of and upload rule,
packaging stored profile-specific metrics and transformations for upload, and
transmitting the packaged profile-specific metrics and transformations to a destination specified in each received profile.

8. The method of claim 7 wherein an upload rule is at least one of a timer or a schedule, or an event condition in the metric stream.

9. An apparatus comprises a processor configured as a multi-client agent.

10. The apparatus of claim 9 wherein the multi-client agent can allow multiple parties to provision (“task”) and maintain profiles on a single device, effectively allowing each tasking authority to talk to its own “virtual” agent which solely serves its needs.

11. The apparatus of claim 9 wherein the agent is responsible
for maintaining and executing each instruction provided within multiple profiles,
for storing data collected by each profile, and
for reporting up to each of the tasking authorities on the schedule specified within each profile.

12. The apparatus of claim 11 wherein maintaining, executing, storing and reporting for one client profile is imperceptible to other on-device clients of the agent and to tasking authorities.

13. The apparatus of claim 9 wherein the agent
receives a single stream of metrics from the system,
performs profile-specific filtering, and
processes metrics for each profile being obeyed at any given time.

14. An apparatus comprises a baseband processor communicatively coupled to a processor and a multi-client agent circuit and a plurality of profile circuits wherein a circuit may be a processor configured by instructions encoded in non-transitory computer readable storage wherein each profile circuit is provisioned by a different tasking authority to collect, package, and transmit metrics to a specified destination and the multi-client agent circuit subscribes to a datastream from the baseband processor to serve all the requirements of all the profile circuits.

15. A method for receiving metrics recorded at a plurality of wireless devices, the method comprising:
receiving, at a data collection agent of each wireless device, a plurality of data collection profiles comprising a series of executable commands which are executed by the data collection agent, the data collection profile defining metrics and survey responses that is to be collected, a condition under which the metrics are to be recorded and a survey launched, and conditions under which the recorded metrics and survey responses are to be transformed and transmitted,
executing, by the data collection agent, the data collection profiles;
determining, by the data collection agent at the wireless device, that a condition defined by one of the data collection profile has occurred;
storing, by the data collection agent, metrics at the wireless device in response to the condition and as specified by the data collection profile;
transforming the stored metrics into a package; and
transmitting the package to a package reception server according to the conditions defined in one of the data collection profiles.

16. The method of claim 15 for recording metrics associated with a wireless device, the method further comprising:
receiving, at a data collection agent of wireless device, a plurality of data collection profiles, each comprising a series of executable commands which are executed by the data collection agent, the data collection profile defining metrics that are to be stored, a condition under which the metrics are to be stored, transformations of the metrics into a package, and conditions under which the package is to be transmitted;
executing, by the data collection agent, the data collection profile;
determining, by the data collection agent at the wireless device, that a condition defined by the data collection profile has occurred;
storing, by the data collection agent, metrics at the wireless device in response to the condition and as specified by the data collection profile;
transforming the stored metrics into a package; and
transmitting the package to a package reception server according to the conditions and at a destination defined in the data collection profile.

17. The method as recited in claim 16, wherein storing the metrics at the wireless device is performed also in response to a configuration of the wireless device being compatible with storage of the metrics.

18. The method as recited in claim 15, further comprising
receiving, at a data collection agent of each wireless device, a a priority screen which assigns a relative priority of each data collection profile to receive resources available on the wireless device.

19. The method as recited in claim 15, further comprising
assigning resources on the wireless device to each of the data collection profiles according to the priority set within a priority screen.

20. The method as recited in claim 15, further comprising
comparing the resources available on a wireless device to a priority screen and determining which data collection profile will not be resourced due to its relative position in said priority screen.
